(19) United States
(12) Patent Application Publication
(10) Pub. No.: US 2018/0077881 A1
(43) Pub. Date: Mar. 22, 2018

(54) WATERING SYSTEM BASED ON A SOLAR PUMP

(71) Applicant: LORENTZ Pump & Mechanics (Beijing) Co., Ltd., Beijing (CN)

(72) Inventors: Bernt LORENTZ, Beijing (CN); Christian Albrecht, Stuvenborn (DE)

(21) Appl. No.: 15/702,800

(22) Filed: Sep. 13, 2017

(30) Foreign Application Priority Data
Sep. 16, 2016 (DE) 102016117446.7

(51) Int. Cl. A01G 25/16; A01G 25/09; H02S 10/10; H02S 20/30

(52) U.S. Cl. CPC A01G 25/16; H02S 20/30; H02S 10/10; A01G 25/09

(57) ABSTRACT

In order to construct a watering system for watering an agricultural area as economically as possible and independently of environmental conditions, it is suggested to supply both a drive for the movement of a watering unit and also a pump system with current or voltage by means of a photovoltaic unit or a plurality of photovoltaic units.

### RELATED APPLICATION

This application claims the benefit of priority of German Patent Application No. 102016117446.7 filed on Sep. 16, 2016, the contents of which are incorporated herein by reference in their entirety.

### FIELD AND BACKGROUND OF THE INVENTION

The invention relates to a watering system for watering an agricultural area, wherein the watering system has at least one watering unit which can be moved by means of at least one drive, wherein the watering system furthermore has at least one photovoltaic unit for supplying power to the at least one drive.

Furthermore, the invention relates to a method for watering an agricultural area based on a watering system.

### PRIOR ART

Mechanized watering systems for watering agricultural areas are known in the prior art. Using such mechanized watering systems, it is possible to automate the watering to the greatest extent, reduce outlay and save costs, particularly wage costs.

In order to move or to travel watering units of a mechanized watering system over an agricultural area, the watering units are usually driven by means of alternating-current motors (AC motors). Generators are used to supply power to these drives, for example diesel generators, or mains connections of a mains supply. Depending on the nature of the environment, the water for the watering is provided by means of a public water supply system or a pump system. Pump systems of this type are likewise usually based on AC motors, which, like the drives of the watering units, are fed by a generator, by means of mechanical force transfer of a shaft of a diesel motor, or by a mains supply.

There are few watering systems known in the prior art wherein the drives of the watering units are driven by means of solar power. When using solar power, the electrical energy obtained is always stored temporarily, in order to ensure a constant supply for the drive motors.

For example, a watering system is known from U.S. Pat. No. 7,878,429 B2, which has a plurality of towers or watering units arranged on wheels and connected to one another. These motors are driven by means of electrical energy, which is obtained by means of a solar system and stored temporarily.

### SUMMARY OF THE INVENTION

It is the object of the present invention to construct a watering system for watering large agricultural areas as economically as possible and independently of environmental conditions.

According to the invention, a watering system for watering an agricultural area is suggested for this, wherein the watering system has at least one watering unit which can be moved over the area by means of at least one drive. The watering system furthermore has at least one photovoltaic unit for supplying power to the at least one drive.

Furthermore, the watering system has at least one solar-powered pump system, which is electrically connected to the at least one photovoltaic unit and/or a further photovoltaic unit for supplying power to the pump system. The photovoltaic unit has at least one solar module. The pump system is connected to the at least one watering unit by means of an operative flow connection.

The watering system is used for watering an agricultural cultivated area, for example for plant and/or cereal watering. The watering system is a mechanized watering system. It therefore does not require continuous manual operation by persons on the field. A watering unit is understood to mean a mechanical unit, for example a tower. The watering unit is constructed to be movable, so that the watering unit can be moved, for example traveled, over a predetermined region of an agricultural area. Furthermore, the watering unit has a pipe system, for example a pipe or a hose for conveying the water. The watering system can have laterally protruding arms or supports, by means of which the water-carrying lines are guided or into which these lines are integrated.

Preferably, the watering unit has at least one wheel, which is driven by the at least one drive. The drive can for example be constructed as a motor. In particular, it is provided in this case that the drive is constructed for variable or adjustable speeds. Thus, the watering unit can be driven and moved at different speeds by means of the drive.

An operative flow connection is understood to mean a connection for conveying water from the pump system to the watering unit. For example, the operative flow connection can be constructed as a pipe or hose. The pump system preferably has an electric motor and a pump. The pump system is used for conveying the water. In this case, the water can be conveyed from a water reservoir, for example a tank, a lake or a river, by means of the at least one pump. Alternatively, groundwater can be conveyed by means of a pump.

Because the at least one watering unit of the watering system according to the invention is moved by means of a drive, which is supplied with power by means of a photovoltaic unit and the pump system is also constructed in a solar-powered manner, the watering system according to the invention is constructed in a particularly economical manner. Furthermore, the watering system according to the invention is consequently independent of environmental conditions and can be used very flexibly. For example, the watering system can also be used in very remote regions, in which there are no public power supply and water supply systems. Diesel generators, as are used in such regions in the prior art for the drives of the watering units and the pumps, require a continuous fuel supply. This is not necessary for the watering systems according to the invention. The manual maintenance outlay is therefore reduced considerably.

Preferably, the at least one pump system is connected to the at least one watering unit, in addition to an operative flow connection, by means of a data connection or communication interface. As a result, the interoperability between the pump system and the watering unit is improved considerably. For example, the speed of the movement of the watering unit and/or the direction of travel thereof can therefore be controlled by means of the pump system. Thus, it is preferably provided that the drive of the watering unit is controlled as a function of parameters of the pump system. For example, the movement speed of the at least one watering unit can be controlled as a function of a flow quantity, a flow rate, an instantaneous solar capacity or solar irradiation, a predetermined requirement of the area to be watered and/or as a function of current environmental conditions, for example a current rainfall. A computer-based control or a controller is provided for this, which is controlled by means of an algorithm or software executing the algorithm. The data connection between the pump system and the watering unit can be constructed in a wired or wireless manner.

The pump system is particularly preferably constructed as a central control unit, that is to say as a master. The pump system or a control assigned to the pump system detects status information and parameters and determines the optimum movement, for example the speed and/or direction of travel, for the watering unit therefrom.

The at least one watering unit is preferably constructed such that it can be traveled linearly and/or can be rotated about an axis. Thus, the at least one watering unit can be traveled along a path, for example a straight path or a path with curves. Furthermore, the at least one watering unit can be rotated and traveled about an axis, for example a virtual axis.

It is also preferably provided that the watering system has a plurality of watering units connected to one another. For example, a central watering unit can be constructed rotatably. Further watering units can be connected one behind the other and to or among one another. These further watering units can therefore be moved by means of the central and rotatably constructed watering unit in such a manner that the watering units together travel a circular path. Each watering unit preferably has at least one wheel for this purpose. At least one watering unit is driven or moved using the drive. The further watering units may have separate drives.

The plurality of watering units are preferably connected to one another by means of mechanical connections and by means of line sections for conveying the liquid or the water for the watering. In this case, rigid struts, or arms, are provided as mechanical connections. The line sections for conveying the water can be constructed as pipes or hoses. These line sections can be integrated into the mechanical connections or attached or fastened externally. Outlet openings in the form of sprinklers or nozzles for the liquid outlet or water outlet can be arranged in each line section.

The at least one photovoltaic system is preferably electrically connected to the at least one drive directly, that is to say without an interposed energy storage device. Furthermore, the at least one photovoltaic unit or a further photovoltaic unit is connected to the pump system directly, that is to say likewise without an interposed energy storage device. As a result, further costs can be reduced and the watering system can be used even more independently of environmental conditions, for example very high outdoor temperatures and direct solar irradiation.

The at least one drive of the watering system is preferably constructed as a direct-current motor (DC motor). Particularly preferably, the DC motor is constructed to be brushless. Variable speeds can be controlled in a particularly suitable manner by means of a DC motor. Furthermore, a DC motor is much more efficient, when viewed economically, than AC motors, especially in connection with a power supply based on a photovoltaic unit. In particular, power consumption at relatively low speeds is substantially lower.

Furthermore, a drive control unit is preferably provided, by means of which the speed of the movement of the at least one watering unit can be adjusted in a variable manner. The drive control unit can be assigned to the pump system and/or the watering unit. The drive control unit is preferably electrically connected to the at least one drive.

Also, it is preferably provided that the at least one photovoltaic unit and/or a further photovoltaic unit is electrically connected to the drive control unit. Thus, the drive control unit can also be supplied with current or voltage by means of the photovoltaic unit. Furthermore, the photovoltaic capacity or radiation intensity can therefore be detected by means of the drive control unit and taken into account when determining the movement or travel movement, for example the speed and/or direction of travel.

The watering system preferably has a hybrid system for additional infeed of an electric current from an external power supply source. A hybrid control unit for controlling the additional power infeed is connected to the pump system and/or the external power supply source for this purpose. The hybrid system therefore essentially has the external power supply source or an interface for the external power supply source and at least one photovoltaic unit and the hybrid control unit. The external power supply source can for example be a generator or a public mains supply. To control the external power portion, the hybrid control unit can have a computer-based control and software or an algorithm. If solar radiation is insufficient at a particular point in time and if the at least one watering unit of the watering system cannot or should not be held up for so long, the required power difference can be provided by the external power supply source.

The pump system preferably has an input interface for receiving status information. Status information may for example be a required watering quantity, the status of the watering unit or the watering units, line pressure data or water pressure data, a flow quantity, a flow rate and/or rainfall in the local watering area.

Furthermore, the pump system preferably has an output interface for outputting information. Information of this type may for example be a line pressure, a flow rate, a system status, information about solar capacity and/or solar voltage, information about the movement profile, for example the movement speed, of the watering unit or the watering units.

Preferably, the input interface is operatively connected to a watering sensor and/or a flow measuring unit and/or a pressure sensor. Thus, the desired parameters or status information can be detected by means of appropriate sensors or measuring units and forwarded to the pump system.

The at least one photovoltaic unit can be arranged directly on a watering unit. For example, a photovoltaic unit can be constructed on a watering unit constructed as a tower. Alternatively, the photovoltaic unit can also be arranged elsewhere and only electrically connected to the watering unit or the drive on the watering unit. Particularly preferably, the at least one photovoltaic unit is mechanically arranged on at least one watering unit, however. Very particularly preferably, the at least one photovoltaic unit is arranged on a central or rotatably constructed watering unit. An electrical connection of the photovoltaic unit arranged on this watering unit to further watering units may be provided. Furthermore, the pump system could be electrically connected to this photovoltaic unit for supplying power. Alternatively, separate photovoltaic units may be provided for further watering units and/or the pump system.

According to the invention, a method for watering an agricultural area using an above-described watering system is furthermore provided.

In this case, it is preferably provided that a speed and/or direction of travel of the movement of the at least one watering unit is controlled and/or regulated by the at least one drive by means of the drive control unit. Thus, the drive and therefore the movement of the watering unit can not only be switched on and off, but rather the speed can be adjusted and regulated in various stages or even in an infinitely variable manner. Particularly preferably, the pump system is in this case constructed as a central control unit and therefore as a master. The watering unit is then constructed as what is known as a slave. This is to be understood to mean that the central control, particularly the control of the drive and the movement speed resulting therefrom is controlled from the pump system and not the individual watering units.

Preferably, the speed and/or the direction of travel is regulated as a function of a predetermined watering quantity and/or a line pressure and/or a water pressure and/or a flow quantity of the water and/or a flow rate of the water and/or a solar capacity and/or rainfall and/or a partial or full shading of one or more solar modules. Status information of this type can be detected continuously, for example at predetermined time intervals, by the pump system or the sensors and measuring units connected thereto, and the speed of the movement and/or the direction of travel of the at least one watering unit can be adjusted or regulated.

Preferably, the movement or the travel behaviour, for example the speed and/or direction of travel, can be regulated in such a manner in this case that an operating point or working point of the watering unit is tuned to an operating point or working point of the pump system. Thus, the regulation of the travel behaviour is provided in such a manner that the operating points or working points of the pump system and the watering unit correlate. If pump performance drops, for example in the case of a relatively low line pressure, water pressure, low flow quantity, flow rate or solar capacity, the speed of the movement of the at least one watering unit can be reduced, so that the watering quantity for the areas traveled in this time essentially remains constant. When pump capacity increases, the speed can be increased again. Thus, it is possible to react to fluctuating working points of the pump system, which leads to a particularly efficient watering system in connection with power supply based on a photovoltaic unit and direct power infeed without temporary storage.

### BRIEF DESCRIPTION OF THE SEVERAL VIEWS OF THE DRAWINGS

In the figures:

FIG. 1: shows a schematic illustration of a watering system with a movable watering unit,

FIG. 2: shows a schematic illustration of a watering system with a plurality of watering units connected to one another, and

FIG. 3: shows a flowchart with the important steps for a method for watering an agricultural area.

### DESCRIPTION OF SPECIFIC EMBODIMENTS OF THE INVENTION

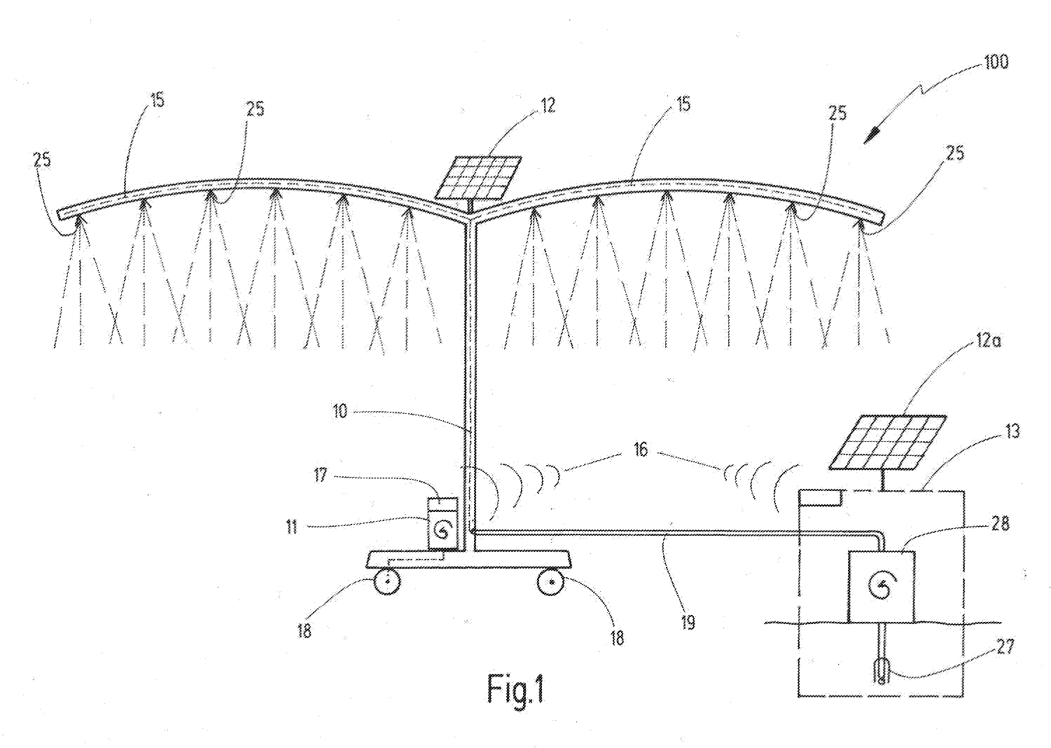

FIG. 1 shows a schematic illustration of a watering system 100 with a movable watering unit 10. The watering unit 10 is constructed as a type of tower and mounted on wheels 18. The watering unit 10 has a drive 11 for variable speeds and drives at least one wheel 18 of the watering unit 10.

The watering unit 10 or a drive control unit 17 of the drive 11 is connected to the pump system 13 by means of a wireless data connection 16. The pump system 13 has a motor 28 and a pump 27 for conveying the water for the watering. The pump system 13 is here constructed as a central control unit or as a master. The movement speed and the direction of travel and therefore the control of the drive 11 is determined by the pump system 13 as a function of status information and environmental conditions. This information is transmitted for example via the data connection 16.

The watering unit 10 including the drive 11 is supplied with current or voltage by means of a photovoltaic unit 12. In the example shown in FIG. 1, the photovoltaic unit 12 is arranged on the watering unit 10 and securely connected to the same. The watering unit 10 has arms with line sections 15 arranged thereon for the distribution of the water for watering. Nozzles 25 for outputting the water for the watering are arranged on the line section 15 in a distributed manner over the length. The watering unit 10 can be traveled linearly or along a predetermined path over an area to be watered. Alternatively, the watering unit 10 can be traveled in the rotating manner or in a circle.

In the example shown in FIG. 1, the pump system 13 is supplied with current or voltage by means of a separate or further photovoltaic unit 12a. In principle, a single photovoltaic unit 12 could also be provided for supplying current or voltage to the pump system 13 and the watering unit 10.

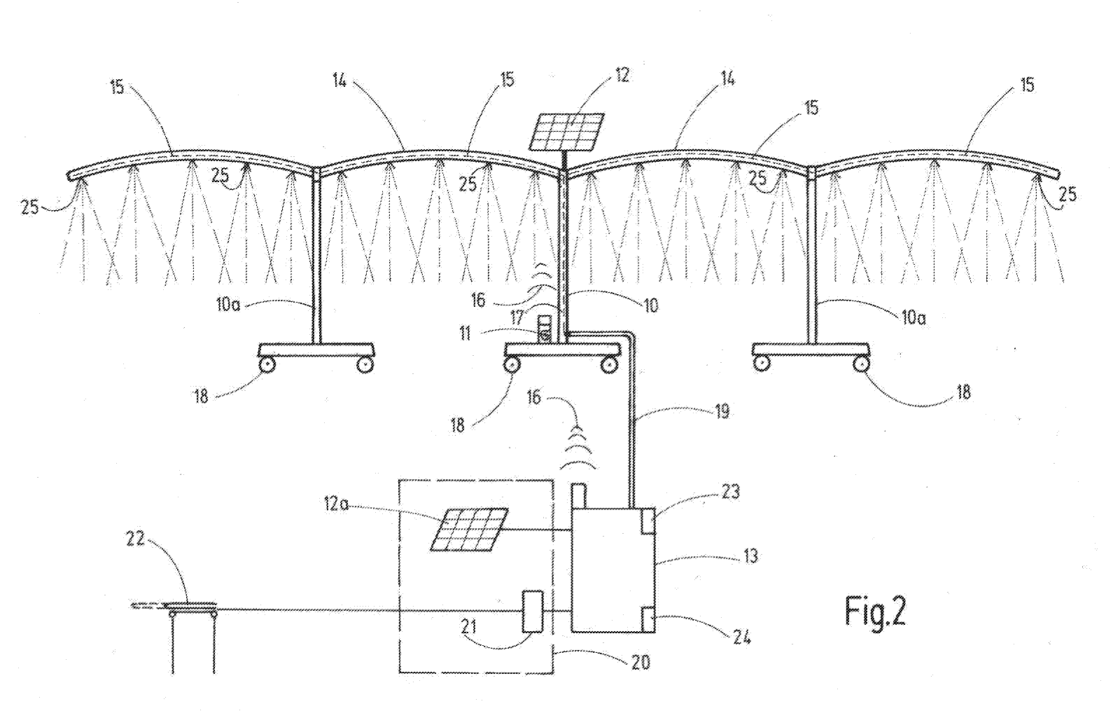

FIG. 2 shows a similar watering system 100 in a schematic illustration, but with a plurality of watering units 10, 10a connected to one another. The central watering unit 10 is constructed similarly to the watering unit 10 shown in FIG. 1. The arms of this watering unit 10 are constructed as mechanical connections 14 to the further watering units 15. Based on this principle, any desired number of watering units 10, 10a can be connected to one another and thus an agricultural area of any desired size can be watered.

In the image shown in FIG. 2, the watering system 100 has a hybrid system 20. The hybrid system 20 has an interface for an external power supply source 22, a hybrid control unit 21 and the further photovoltaic unit 12a for this purpose. The quantity of power to be fed in from the exterior is regulated by means of the hybrid control unit. In the event of relatively low solar irradiation, the power requirement for the pump system 13 and/or the watering unit 10 or the drive 11 of the watering unit 10 can be supplemented by means of external power from the power supply source 22. The power from the external power supply source 22 is fed into the photovoltaic unit 12a and/or the pump system 13 in such a manner for this purpose that, furthermore, no temporary storage of the energy is necessary.

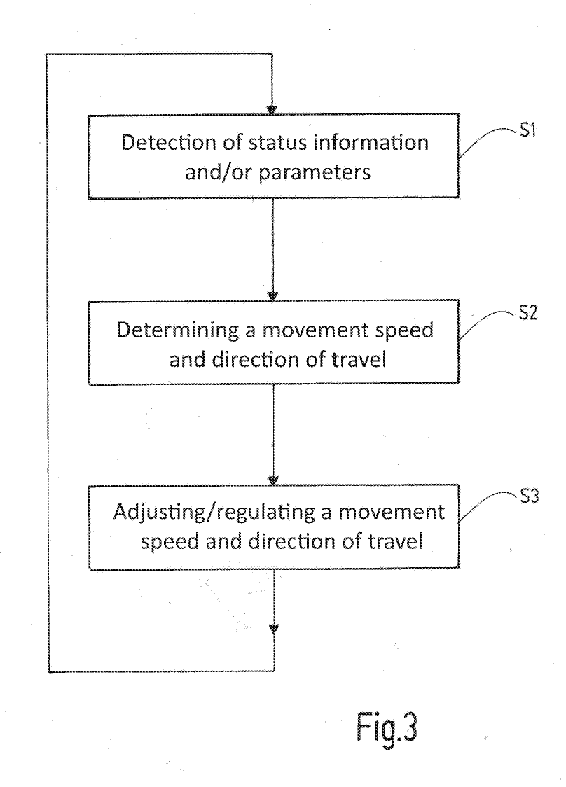

FIG. 3 shows a schematic illustration for a flow chart of a method for watering an agricultural area. In this case, in FIG. 3, the sequence is shown on the basis of the important steps. In step S1, status information and/or parameters such as for example rainfall, line pressure, water pressure and/or solar capacity are detected. On the basis of this information or parameters, the movement speed and direction of travel are determined by the pump system 13 in step S2. During the determination, the working points of the pump system 13 and the watering unit 10 are compared to one another. In the next step, on the basis of the determined movement speed and direction of travel, in step S3 the watering unit 10 is driven in such a manner by means of the drive 11 that the watering unit is traveled or moved with the desired speed and direction of travel.

### REFERENCES

100 Watering system
10, 10a Watering unit
11 Drive
12, 12a Photovoltaic unit
13 Pump system
14 Mechanical connection
15 Line section
16 Data connection
17 Drive control unit
18 Wheel
19 Operative flow connection
20 Hybrid system
21 Hybrid control unit
22 Power supply source
23 Input interface
24 Output interface
25 Nozzle
27 Pump
28 Motor
S1 Detection of status information and/or parameters
S2 Determining a movement speed and direction of travel
S3 Adjusting/regulating a movement speed and direction of travel

What is claimed is:

1. A watering system (100) for watering an agricultural area, the watering system (100) having at least one watering unit (10) which can be moved by means of at least one drive (11), the watering system (100) furthermore having at least one photovoltaic unit (12) for supplying power to the at least one drive (11),
characterized
in that the watering system (100) has at least one solar-powered pump system (13), which is electrically connected to the at least one photovoltaic unit (12) and/or a further photovoltaic unit (12a) for supplying power to the pump system (13), wherein the pump system (13) is connected to the at least one watering unit (10) by means of an operative flow connection (19).

2. The watering system (100) according to claim 1,
characterized
in that to improve the interoperability, the at least one pump system (13) is connected to the at least one watering unit (10), in addition to an operative flow connection, by means of a data connection (16).

3. The watering system (100) according to claim 1,
characterized
in that the at least one watering unit (10) is constructed such that it can be traveled linearly and/or can be rotated about an axis.

4. The watering system (100) according to claim 1,
characterized
in that the watering system (100) has a plurality of watering units (10, 10a) connected to one another.

5. The watering system (100) according to claim 4,
characterized
in that the watering units (10, 10a) are connected to one another by means of mechanical connections (14) and by means of line sections (15) for conveying a liquid for the watering.

6. The watering system (100) according to claim 1,
characterized
in that the at least one photovoltaic unit (12) is electrically connected to the at least one drive (11) directly without an interposed energy storage device.

7. The watering system (100) according to claim 1,
characterized
in that the at least one drive (11) is constructed as a direct-current motor, wherein a speed of the movement and/or a direction of travel of the at least one watering unit (10) can be adjusted in a variable manner by means of a drive control unit (17).

8. The watering system (100) according to claim 7,
characterized
in that the at least one photovoltaic unit (12) and/or a further photovoltaic unit (12a) is electrically connected to the drive control unit (17).

9. The watering system (100) according to claim 1,
characterized
in that the watering system (100) preferably has a hybrid system (20) for additional infeed of an electric current from an external power supply source (22), wherein a hybrid control unit (21) for controlling the additional power infeed is connected to the pump system (13) and/or the external power supply source (22).

10. The watering system (100) according to claim 1,
characterized
in that the pump system (13) has an input interface (23) for receiving status information and/or an output interface (24) for outputting information.

11. The watering system (100) according to claim 10,
characterized
in that the input interface (23) is operatively connected to a watering sensor and/or a flow measuring unit and/or a pressure sensor.

12. The watering system (100) according to claim 1,
characterized
in that the at least one photovoltaic unit (12) is mechanically arranged on the at least one watering unit (10).

13. A method for watering an agricultural surface using a watering system (100) according to claim 1.

14. The method according to claim 13,
characterized
in that a speed of the movement and/or a direction of travel of the at least one watering unit (10) is controlled and/or regulated by the at least one drive (11) by means of a drive control unit (17).

15. The method according to claim 14,
characterized
in that the speed and/or the direction of travel is regulated as a function of a predetermined watering quantity and/or a line pressure and/or a flow quantity and/or a flow rate and/or a solar capacity and/or rainfall.

16. The method according to claim 14,
characterized
in that the speed and/or the direction of travel is regulated in such a manner that an operating point of the watering unit (10) is tuned to an operating point of the pump system (13).
